(19) United States
(12) Patent Application Publication
(10) Pub. No.: US 2006/0136188 A1
(43) Pub. Date: Jun. 22, 2006

(54) Capturing curation data

(76) Inventors: David John Lacey, Frisco, TX (US); Nathan Dirk Zelle, Dallas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/021,709

(22) Filed: Dec. 22, 2004

(51) Int. Cl. G06F 17/50

(52) U.S. Cl. 703/14

(57) ABSTRACT

Exemplary techniques for capturing curation data are described. In a described embodiment, a method comprises capturing curation data corresponding to a proposed design model; generating a manifest of a plurality of files identified by the captured curation data; validating stability of the proposed design model by performing one or more commands identified by the captured curation data; and releasing the validated design model in accordance with one or more instructions identified by the captured curation data.

### TECHNICAL FIELD

The present description generally relates to electronic computing. More particularly, an embodiment relates to capturing curation data.

### BACKGROUND

Curation is generally utilized when designing integrated circuits (ICs). Often, various engineering teams work on different blocks of an IC design simultaneously. Each block may be represented in various computer files. To build a full model of the IC, a curation process is utilized to pull together a desired version of each of these blocks that are under design by the various design teams.

Generally, curation efforts are time-consuming, in part, because they often involve manual intervention by an operator. Also, on the same project, different curation methodologies may be utilized by different teams within that one project. These methodologies can often be incompatible, and maintaining these different curation efforts across a project is inefficient. Furthermore, with distributed and separate curation tools, it is difficult to make global curation changes across an entire project.

### SUMMARY

In a described embodiment, a method comprises capturing curation data corresponding to a proposed design model; generating a manifest of a plurality of files identified by the captured curation data; validating stability of the proposed design model by performing one or more commands identified by the captured curation data; and releasing the validated design model in accordance with one or more instructions identified by the captured curation data.

In another described embodiment, a system comprises one or more model curation modules to perform a plurality of tasks corresponding to a proposed design model; and a curation data storage unit communicatively coupled to the one or more model curation modules and configured to store captured curation data, wherein the stored curation data is utilized to curate the proposed design model.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an exemplary curation system, according to an embodiment.

FIG. 2 illustrates an exemplary method of capturing curation data, according to an embodiment.

FIG. 3 illustrates an exemplary hierarchical design model which utilizes multiple curation data sources, according to an embodiment.

FIG. 4 illustrates various components of an exemplary computing device which may be utilized to implement portions of the techniques discussed herein, according to an embodiment.

### DETAILED DESCRIPTION

Exemplary techniques for capturing curation data are described. The techniques enable the abstraction of the curation details from curation tools. For example, a text file may be utilized which includes predetermined keywords to allow for the details that make each model's curation efforts unique to be captured and documented in a single location. With this approach, the curation efforts may be easily automated by a set of model-independent curation tools, for example, by allowing periodic stability checks of a model and/or by using a customizable set of common tools and/or processes across different models.

Such embodiments are envisioned to reduce maintenance costs associated with model curation, in part, due to the uniformity of tools applied across multiple models (e.g., which may correspond to entirely different projects). This may further reduce or eliminate frequent operator intervention. Additionally, global curation changes may be more readily made across an entire project.

Curation System Overview

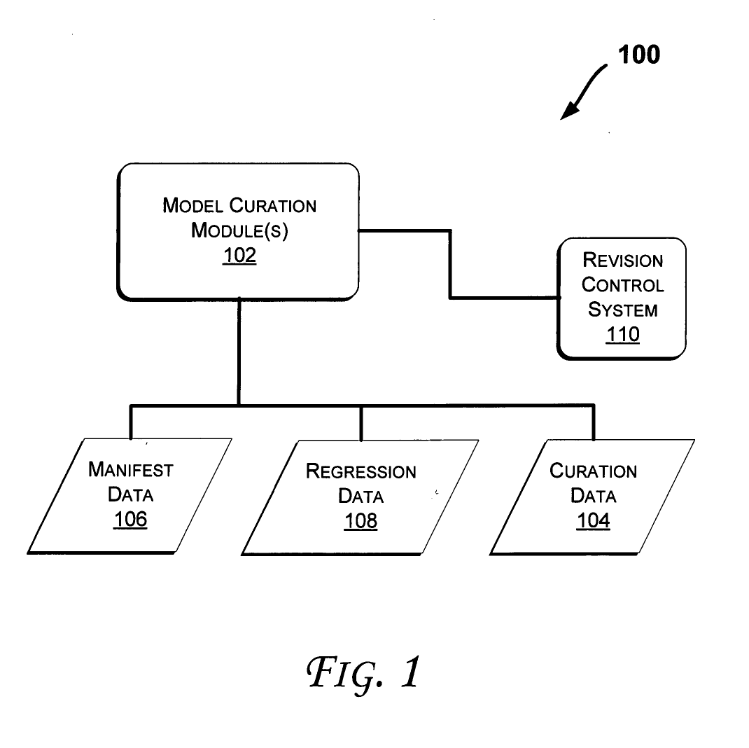

FIG. 1 illustrates an exemplary curation system 100. The curation system 100 includes one or more model curation modules (or software tools) 102 to perform the tasks associated with a design modeling process. The model curation modules (which may be implemented as a single module in an embodiment) may include a curation data capture module to capture curation data corresponding to a proposed design model and store it in a curation data storage unit 104. The model curation modules may further include a manifest generation module to generate a manifest or list of files that are used for a proposed design model (that may be stored in a manifest data storage unit 106), a stability validation module to validate the stability of the proposed design model by running one or more validation commands and store the results in a regression data storage unit 108, a model release module to release the validated design model (e.g., to a revision control system 110), and a scheduler module to manage the other modules, and the curation process more generally. In an embodiment, the scheduler module runs the other curation modules at a predetermined schedule, for example, hourly, daily, weekly, and the like.

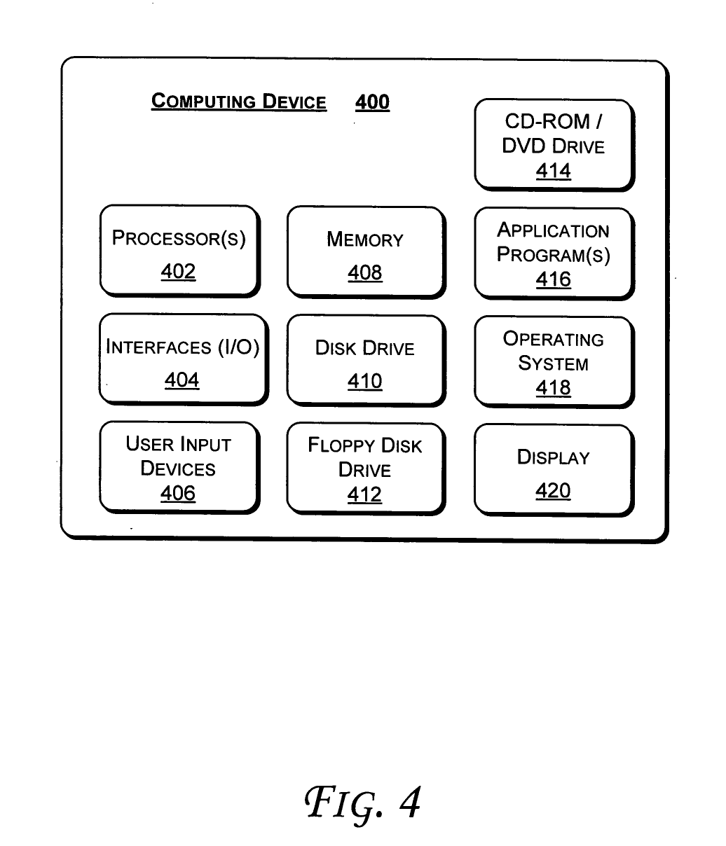

The data 104-108 may include one or more electronic storage units (such as those discussed with reference to FIG. 4), e.g., one or more files, databases, etc. that may be physically located at various locations (including remote locations). The curation data 104 may include one or more types of data such as a file name, a directory name, a revision number or identifier, and/or a tag to assist in generating a manifest of the files used in the curation process. Moreover, specific files or directories may be included or excluded from the curation data 104. Furthermore, the curation data 104 may include a reference to one or more previously generated manifest files, e.g., to be merged into the manifest currently being generated.

The curation data 104 may include one or more types of data such as a validation command (e.g., to specify detailed commands to execute to validate the stability of the proposed model), a release instruction (e.g., to specifies additional steps to take when releasing a new model—this provides for creation of model archives, distribution, etc.), and/or a distribution list. The release instructions may include a tag which is to be used for the next release of the model and configuration data which specifies details that are to be captured for the build processes of the validation environment.

The revision control system (RCS) 110 may be in electronic communication with one or more of the model curation modules 102. The RCS 110 may be implemented as a database, a file, and the like. The RCS 110 may retain a history of changes to one or more files. The RCS 110 may assign a version number or identifier to the one or more files each time a change is saved. Accordingly, the RCS 110 may capture an image of each individual change upon submission of that change to the RCS 110. For example, in a chip design scenario, an engineer may change the design of an IC sub-block, and upon obtaining a satisfactory result, the engineer may submit the change (that may identify a number of associated files) to an RCS. The RCS will in turn assign revision number(s) or identifier(s) to the new or changed file(s) and maintain data regarding the revision made by the engineer, for example, for future processing by model curation modules.

Capturing Curation Data

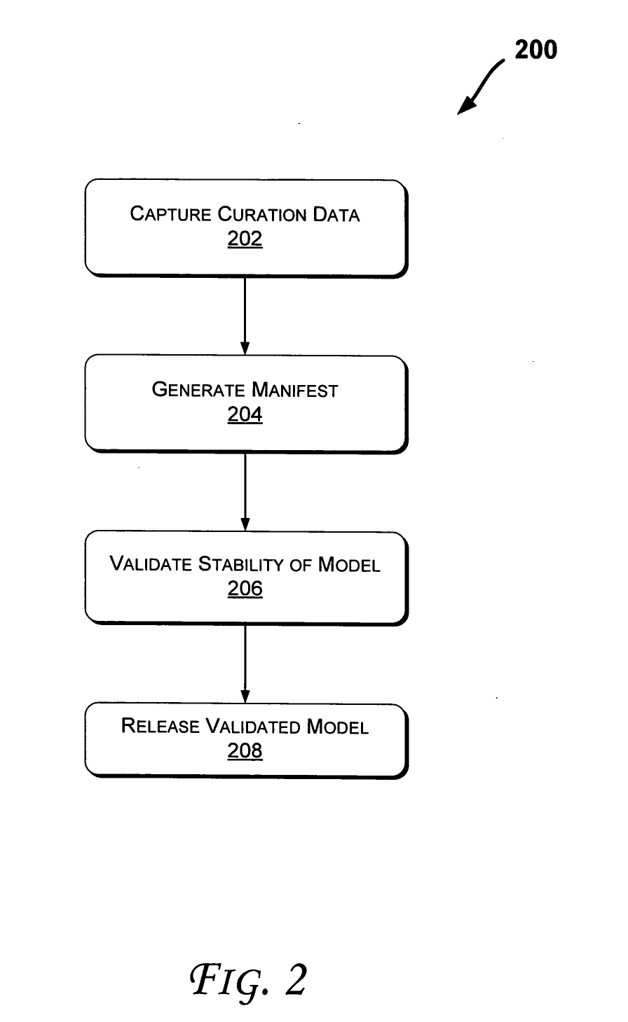

FIG. 2 illustrates an exemplary method 200 of capturing curation data. In one embodiment, the design model corresponds to an IC design. The method 200 captures curation data (202) that may correspond to a proposed design model. As discussed with reference to FIG. 1, the captured curation data may be stored in a file and the captured curation data may include one or more types of data such as a file name, a directory name, a revision number or identifier, a tag, a validation command, a release instruction, and a distribution list.

The method 200 generates a manifest of a plurality of files identified by the captured curation data (204). The manifest may be stored in a file such as discussed with reference to the manifest data 106 of FIG. 1. The plurality of files may be identified by the curation data 104, as discussed with reference to FIG. 1. Also, the revision control system (such as 110 of FIG. 1) may be utilized to generate the manifest of the plurality of files.

The stability of the proposed design model is validated (206), e.g., by performing one or more commands identified by the captured curation data such as those discussed with reference to the curation data 104 of FIG. 1. For example, the regression results may be checked to determine whether the files contained within the generated manifest (e.g., 106 of FIG. 1) represent a model with a minimum level of correctness. The exact definition of this minimum level of correctness may be predetermined and described in a file (e.g., the curation data 104 of FIG. 1). Finally, the validated design model is released (208), e.g., in accordance with one or more instructions identified by the captured curation data such as those discussed with reference to the curation data 104 of FIG. 1.

In an embodiment, one or more results of the method may be distributed to a distribution list (e.g., as identified by the curation data 104 of FIG. 1). The distribution may include one or more email addresses, pager numbers, telephone numbers, and the like. Also, the revision control system (e.g., 110 of FIG. 1) may be updated once the proposed design model is released (208).

Hierarchical Design Model

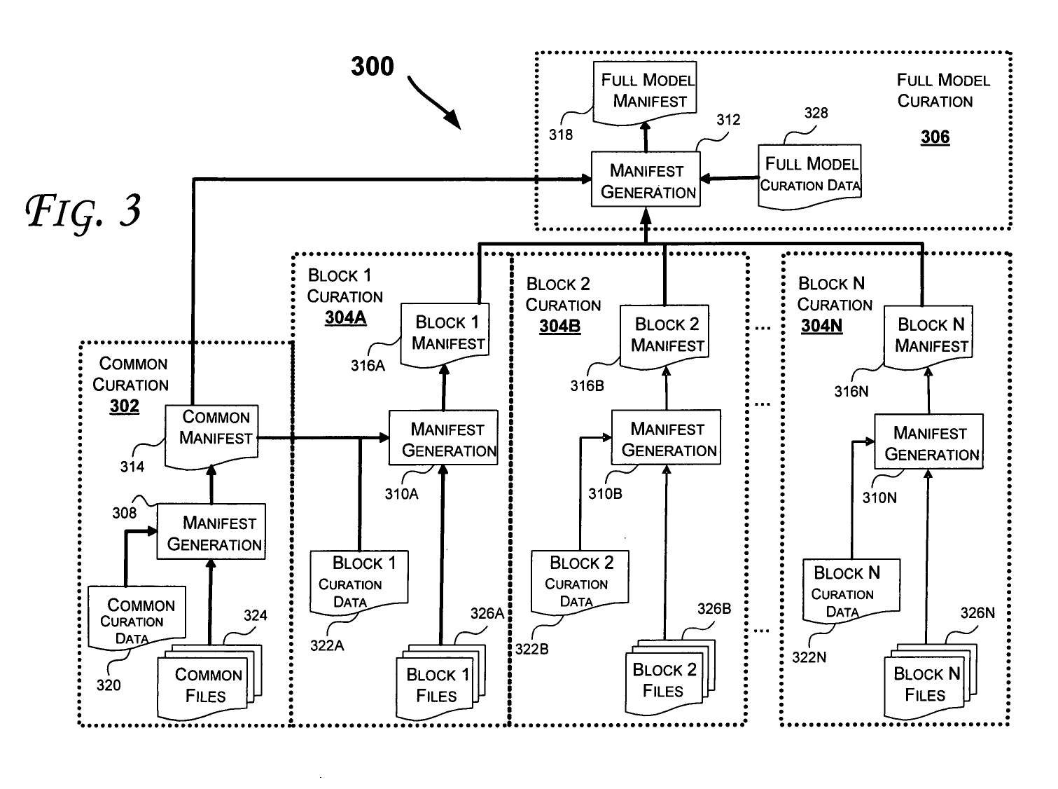

FIG. 3 illustrates an exemplary hierarchical design model 300 which utilizes multiple curation data sources. In one embodiment, the arrows shown in FIG. 3 illustrate the direction of data flow between the modules of the hierarchical design model 300. The model 300 includes a common curation block 302 (which may be a portion of the model which remains the same for various generations of a design), one or more blocks 304A-N, and a full model curation block 306. In an embodiment, the model 300 may be utilized to provide a chip-level curation. For example, a device such as an IC may be divided into multiple blocks and each sub-block may be curated as illustrated in FIG. 3. The model 300 enables the multiple blocks to be treated as a single design model to provide a chip-level curation.

As illustrated in FIG. 3, each block 302, 304A-N, and 306 includes a manifest generation module (308, 310A-N, and 312, respectively) to generate a manifest (such discussed with reference to 204 of FIG. 2). More particularly, each manifest generation module generates a corresponding block manifest (e.g., 314, 316A-N, and 318, respectively) based on information obtained from the respective block's curation data (e.g., 320 and 322A-N, respectively) and files (e.g., 324 and 326A-N, respectively). Accordingly, each block may be curated in accordance with its respective curation data.

The manifest generation module 312 of the full model curation block 306 may generate the full model manifest 318 from the common manifest 314, the individual block manifests (316A-N) and full model curation data 328. In an embodiment, the curation data 320, 322A-N, and 328 includes information such as discussed with reference to the curation data 104. Also, the files 324 and 326A-N may include information such as those discussed with reference to the revision control system 110, or other files corresponding to the design model at hand.

Thus, the hierarchical design model 300 may be utilized to generate manifests for sub-blocks of a chip which may then be combined to provide a chip-level manifest. Also, when using a hierarchical curation approach, problems found in lower level curation units (e.g., a sub-block) do not have to impact the higher level curation unit since the higher level units can use a previously captured lower level manifest which meets a minimum level of correctness (e.g., a last known good version).

Exemplary Computing Environment

FIG. 4 illustrates various components of an exemplary computing device 400 which may be utilized to implement portions of the techniques discussed herein. In one embodiment, the computing device 400 can be used to perform the method of FIG. 2. The computing device 400 may also be used to provide the system 100 and model 300.

The computing device 400 includes one or more processor(s) 402 (e.g., microprocessors, controllers, etc.), input/output interfaces 404 for the input and/or output of data, and user input devices 406. The processor(s) 402 process various instructions to control the operation of the computing device 400, while the input/output interfaces 404 provide a mechanism for the computing device 400 to communicate with other electronic and computing devices. The user input devices 406 can include a keyboard, mouse, pointing device, and/or other mechanisms to interact with, and to input information to the computing device 400.

The input/output interfaces 404 can include serial, parallel, and/or network interfaces. A network interface allows devices coupled to a common data communication network to communicate information with the computing device 400. Similarly, a communication interface, such as a serial and/or parallel interface, a universal serial bus (USB) interface, an Ethernet interface, an Institute of Electrical & Electronics Engineers (IEEE) 802.11 interface, and/or any combination of wireless or wired communication interfaces provides a data communication path directly (or through intermediate computing device(s) or network component(s)) between the computing device 400 and another electronic or computing device.

The computing device 400 may also include a memory 408 (such as read-only memory (ROM) and/or random-access memory (RAM)), a disk drive 410, a floppy disk drive 412, and a compact disk read-only memory (CD-ROM) and/or digital video disk (DVD) drive 414, which may provide data storage mechanisms for the computing device 400. Any number and combination of memory and storage devices can be connected with, or implemented within, the computing device 400. Although not shown, a system bus typically connects the various components within the computing device 400.

The computing device 400 also includes one or more application program(s) 416 and an operating system 418 which can be stored in non-volatile memory (e.g., the memory 408) and executed on the processor(s) 402 to provide a runtime environment in which the application program(s) 416 can run or execute. The computing device 400 can also include an integrated display device 420, such as for a PDA, a portable computing device, and any other mobile computing device.

Select embodiments discussed herein (such as those discussed with reference to FIGS. 1-3) may include various operations. These operations may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other types of media or machine-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

Thus, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. For example, the techniques discussed herein may be applied to any curation process to provide efficiency, adaptability, and/or ease of maintenance.

What is claimed is:

1. A method comprising:
capturing curation data corresponding to a proposed design model;
generating a manifest of a plurality of files identified by the captured curation data;
validating stability of the proposed design model by performing one or more commands identified by the captured curation data; and
releasing the validated design model in accordance with one or more instructions identified by the captured curation data.

2. The method of claim 1, wherein the captured curation data is stored in a file.

3. The method of claim 1, wherein the captured curation data comprises one or more types of data selected from a group comprising a file name, a directory name, a revision identifier, a tag, a validation command, a release instruction, and a distribution list.

4. The method of claim 1, further comprising distributing one or more results of the method to a distribution list.

5. The method of claim 1, further comprising utilizing a revision control system to generate the manifest of the plurality of files.

6. The method of claim 1, further comprising updating a revision control system once the proposed design model is released.

7. The method of claim 1, wherein the generated manifest is stored in a data file.

8. The method of claim 1, wherein the design model corresponds to an integrated circuit.

9. The method of claim 1, wherein the method is applied to a plurality of hierarchical sub-blocks of the design model.

10. The method of claim 1, wherein the method is applied to a plurality of hierarchical sub-blocks of the design model and a full model manifest is generated by combining a plurality of manifests, each of the plurality of the manifests corresponding to an individual sub-block of the plurality of hierarchical sub-blocks.

11. The method of claim 1, wherein the method is applied to a plurality of hierarchical sub-blocks of the design model and a full model manifest is generated by combining a plurality of manifests, each of the plurality of the manifests corresponding to an individual sub-block of the plurality of hierarchical sub-blocks, wherein each of the plurality of manifests meets a minimum level of correctness.

12. A system comprising:
one or more model curation modules to perform a plurality of tasks corresponding to a proposed design model; and
a curation data storage unit communicatively coupled to the one or more model curation modules and configured to store captured curation data,
wherein the stored curation data is utilized to curate the proposed design model.

13. The system of claim 12, wherein the one or more model curation modules are selected from a group comprising a curation data capture module, a manifest generation module, a stability validation module, a model release module, and a scheduler module.

14. The system of claim 12, wherein the captured curation data comprises one or more types of data selected from a group comprising a file name, a directory name, a revision identifier, a tag, a validation command, a release instruction, and a distribution list.

15. The system of claim 12, wherein the design model corresponds to an integrated circuit.

16. One or more computer-readable media having instructions stored thereon that, when executed, direct a machine to perform acts comprising:
capturing curation data corresponding to a proposed design model;
generating a manifest of a plurality of files identified by the captured curation data;
validating stability of the proposed design model by performing one or more commands identified by the captured curation data; and
releasing the validated design model in accordance with one or more instructions identified by the captured curation data.

17. The computer-readable medium of claim 16, wherein the acts further comprise distributing one or more results of the performed acts to a distribution list.

18. The computer-readable medium of claim 16, wherein the acts further comprise utilizing a revision control system to generate the manifest of the plurality of files.

19. The computer-readable medium of claim 16, wherein the acts further comprise updating a revision control system once the proposed design model is released.

20. The computer-readable medium of claim 16, wherein the captured curation data comprises one or more types of data selected from a group comprising a file name, a directory name, a revision identifier, a tag, a validation command, a release instruction, and a distribution list.

21. An apparatus comprising:
means for capturing curation data corresponding to a proposed design model;
means for generating a manifest of a plurality of files identified by the captured curation data; and
means for validating stability of the proposed design model by performing one or more commands identified by the captured curation data.

22. The apparatus of claim 21, further comprising means for utilizing a revision control system for generating the manifest of the plurality of files.
